(19) United States
(12) Patent Application Publication
(10) Pub. No.: US 2025/0375349 A1
(43) Pub. Date: Dec. 11, 2025

(54) WATER MASSAGE APPARATUS

(71) Applicant: CORE PACIFIC INC., Houston, TX (US)

(72) Inventor: Patrick GWEN, Houston, TX (US)

(21) Appl. No.: 18/737,334

(22) Filed: Jun. 7, 2024

(51) Int. Cl. A61H 33/00

(52) U.S. Cl. CPC A61H 33/6047

(57) ABSTRACT

A water massage apparatus for use with a tub that contains a liquid includes a motor having a shaft, a housing having an interior, an impeller positioned in the interior of the housing, and a cap having at least a portion received within the housing. The shaft has a magnet affixed thereto. The motor is adapted to be affixed to an exterior of the tub such that the magnet faces the surface of the tub. The impeller has a magnetic surface which is attracted to the magnet of the motor. The impeller is rotatable within the housing in correspondence to a rotation of the shaft of the motor. The cap has at least one jet outlet formed thereon or affixed thereto. The impeller is adapted to pass the liquid outwardly of the jet. The cap is driven in rotation by motion of the liquid within the interior of the housing.

### CROSS-REFERENCE TO RELATED APPLICATIONS

Not applicable.

### BACKGROUND OF THE INVENTION

The present invention relates to items for use in pedicure spas. More particularly, the present invention relates to tubs that are used for the soaking of feet. More particularly, the present invention relates to water massage apparatus that are adapted to be used with the tub so as to produce turbulence and bubbles within the fluid in the tub.

Spa devices and systems are known in the art. Spa devices are used in commercial and recreational settings for hydrotherapy, massage, stimulation, pedicure and bathing purposes. In pedicure spas, tubs are typically filled with a liquid so that the feet can of the customer can be soaked within the liquid in the tub. This soaking softens the tissues and nails of the foot so as to make the pedicure procedure easier and more comfortable. Additionally, the soaking of the feet also conveys a sense of wellness and comfort to the customer of the pedicure spas.

Whenever these liquid-containing tubs are used in the pedicure spa, it is always important to maintain the sanitary conditions associated with the liquid and with the tub. As such, a liner is commonly used in association with the tub. This liner is disposable. When these liners are used to maintain the sanitation of the tub and the liquid within the tub, it is often difficult to impart turbulence and/or bubbles to the liquid within the tub.

As such, it is known, in the past, to provide fluid pumps that include a portion on the exterior of the tub and a portion on the interior of the tub such that the portion on the interior of the tub can generate turbulence and bubbles while being actuated by a motor located on the exterior of the tub. A magnetic attraction is established between a magnet of the motor and a magnet of the pump so that an impeller within a housing on the interior of the tub can generate the turbulence and bubbles through the use of jets associated therewith.

The turbulence and bubbles can be quite important to the person receiving the treatment. The turbulence and bubbles give a feeling of well-being and feeling of a massage. It is well known, through the art of reflexology, that the application of pressures onto the surfaces of the foot can generate favorable feelings on the part of the user. In the past, the jets associated with such water pumps were stationary. As such, the application of these forces by the water pump were typically constant. While this constant generation of forces and bubbles is desirable, it does not apply a varying force to the surfaces of the foot. As such, a need to develop so as to provide a water pump that continuously rotates the jets so as to provide a varied massage experience to the feet of the user.

FIGS. 1-3 herein describe a prior art water massage apparatus that can be magnetically coupled between the fluid pump and the motor and used in association with a foot spa. This prior art shown in FIGS. 1-3 is particularly illustrated in U.S. Pat. No. 11,698,079, issued on Jul. 11, 2023 to Le et al.

In particular, FIG. 1 shows a jet assembly 180 and a motor assembly 200. The jet assembly 180 and the motor assembly 200 dispenses fluid in a work environment as a setting SET, such as a foot spa, a spa, a Jacuzzi, a bathtub or a swimming pool. The jet assembly 180 is secured, attached or coupled to the motor assembly 200 by the assistance of the mounting housing member 250.

The jet assembly housing 181 includes a base 182, a front or top cover 183, and an impeller-receiving chamber 184 defined by the base 182 and front or top cover 183. A plurality of inlet apertures 185 are dimensioned and configured to allow fluid to enter the jet assembly housing 181 and are preferably disposed about the central area of the front or top cover 183. A plurality of outlet apertures 186 are dimensioned and configured to allow the fluid to exit or be dispensed from the jet assembly housing into the setting SET and preferably disposed about the periphery of the front or top cover 183.

FIG. 2 shows the application of the jet assembly 180 and the motor assembly 200 to a spa tub. It can be seen that the motor is located on the exterior of the spa tub. A mounting housing member or coupling device 250 is included on an inner wall of the tub. A liner 290 can be juxtaposed against the mounting housing member or coupling device 250 so as to provide a sanitary condition to the interior of the tub. The base of the jet assembly 180 has an inner surface 191, an outer surface 192, a circular wall 193 and a plurality of feet extensions 198. Preferably, the outer surface 192 is generally flat or has a generally flat, centrally-located section that allows for the liner 290 to be position behind (or below) the base 182 of the jet assembly 188 in front of the contact surface of the tub and motor assembly 200, as shown in FIG. 2. Each of the plurality of feet extensions 198 extends outwardly from about the rear or bottom of the circular wall 193 and has a knob 299 extending rearwardly or downwardly from the corresponding feet extension 198 for engaging with the mounting housing member 250. Each of the plurality of engagement recesses or grooves 199 is positioned at a predetermined location about the outer surface 195 of the circular wall 193 for engaging with and securing the front or top cover 183.

FIG. 3 is an exploded view of this prior art water massage apparatus. The jet assembly 180 has a printed circuit board 270 and a cover 280. There is a shaft assembly 140 and an impeller 170. The jet assembly 180 includes a base 182, a front or top cover 183, and an impeller-receiving chamber 184 defined by the base 182 and a front or top cover 183. A plurality of inlet apertures 185 are dimensioned and configured to allow fluid to enter the jet assembly 180 and are disposed about the central area of the front or top cover 183. A plurality of outlet apertures 186 are dimensioned and configured to allow the fluid to exit or to be dispensed from the jet assembly housing into the tub. The plurality of outlet apertures 186 are disposed about the periphery of the front or top cover 183.

The base 182 of the jet assembly housing 180 has an inner surface 191, an outer surface 192, a circular wall 193 at or about the periphery of the base 182, plurality of feet extensions 198, and a plurality of gate engagement recesses or grooves 199. The circular wall 193 has an inner surface 194, an outer surface 195, a front or top 196, and a rear or bottom 197. Each of the plurality of feet extensions 198 extends outwardly from about the rear or bottom 197 of the circular wall 193. There is a knob 299 extending rearwardly or downwardly from the corresponding feet extension 198 for engaging with the mounting housing member 250. Each of the plurality of engagement recesses are grooves 199 positioned at a predetermined location about the outer surface 195 of the circular wall 193 for engaging with and securing the front or top cover 183.

The front or top cover 183 of the jet assembly 180 has an inner surface 231, an outer surface 232, a circular wall 233 at or about the periphery of the front or top cover 183, a plurality of engagement protrusions and the lock-receiving cavity. The circular wall 233 has an inner surface.

The motor 200 will include a shaft that has a base and a cylindrical body extending upwardly from the base. The shaft and the shaft protection member 160 are secured, attached, affixed or mounted within the housing 181. It is preferably mounted in a central location upon the inner surface 191 of the base 182 of the housing 181 of the jet assembly 180 via the base of the shaft member. A locking mechanism will secure the impeller 170 within the housing 181 of the jet assembly 180. The impeller 170 is a magnetic impeller with a planar magnetic impeller and has an outer diameter and a disc-like configuration or shape. The impeller 170 has a front side 172, a rear side 174, a side wall 176, a circular array of arm members 174 position on the front side 172, a centrally-disposed cavity 179 dimensioned and configured for receiving an outer bearing member, an inner bearing member, a shaft member and the shaft protection member 160. The centrally-disposed cavity 170 preferably extends from the front side 172 through to the rear side 174. The magnetic impeller 170 is configured to rotate about the shaft member and shaft protection member 160 and rotate within the impeller-receiving chamber 184. The magnetic impeller 170 is formed in whole or in part of a magnetic pole array that interacts with a magnetic pole array of the driven magnetic disc so as to rotate the magnetic impeller 170 about the shaft member and shaft protection member 160 such that rotation of the magnetic impeller 170 causes the fluid to flow into the inlet aperture 185 and out of the outlet aperture 186.

As can be seen in FIGS. 1-3 of the prior art, the jet outlets 186 of the top cover 183 are in a fixed position. The top cover is fixedly mounted within the housing so as to be non-rotatable therein. As such, the water jets or fluid jets that are emitted through the outlet jets 186 will be in a fixed position. This produces a constant pulsing of the water massage apparatus in generally the same area of the user's ankles or feet. The delivery of the bubbles or turbulence is constant and will not vary. As such, it was important, in the present invention, to configure the water massage apparatus to have a variable delivery of such turbulence, fluid pressure and/or bubbles within the fluid of the spa tub.

In the past, various patents have issued for such water massage apparatus. For example, U.S. Pat. No. 9,855,188, issued in Jan. 2, 2018 to Le et al., shows a system and method for a multifunction magnetic coupling jet. This apparatus includes a motor assembly having a motor. A jet assembly is coupled to the motor assembly. The jet assembly has an inlet and an outlet aperture. An impeller is configured to rotate so as to cause a first fluid to flow into the inlet aperture and out the outlet aperture. A fluid guider includes at least one wall member defining the first channel configured to guide the first fluid from the inlet portion into the cavity. The fluid guider includes at least one post defining the second channel extending through the post. The second channel is configured to guide the first fluid from the cavity towards the outlet aperture and output the first fluid at an oblique angle with respect to a longitudinal axis of the post. A second fluid channel member is configured to provide a second fluid out of the outlet aperture.

U.S. Pat. No. 9,926,933, issued on Mar. 27, 2018 to Le et al., describes an improved bearing and shaft assembly for a jet assembly. This improved bearing and shaft assembly includes a bearing assembly having an outer bearing member and an inner bearing member. The shaft assembly has a shaft member, a shaft protection member, and a locking mechanism. The jet assembly includes an improved bearing and shaft assembly. The jet assembly is coupled to a motor assembly. The jet assembly further includes a housing that includes at least one inlet aperture and at least one outlet aperture. An impeller is positioned within a cavity of the housing.

U.S. Pat. No. 10,215,177, issued in Feb. 26, 2019 to Le et al., shows a fluid pump for dispensing a fluid. The fluid pump has a contactless, fluid sensor for use with a liner. The pump includes a jet assembly, a motor assembly and a contactless fluid sensor. The pump further includes a mounting housing member, a gasket or seal, and a liner. The jet assembly is coupled to or secured about the motor assembly. The jet assembly includes a jet assembly housing, a printed circuit board, a printed circuit board cover, a shaft assembly and an impeller. The jet assembly housing includes a base, a top cover, an impeller-receiving chamber, at least one inlet portion, and at least one outlet portion.

U.S. Pat. No. 10,278,894, issued on May 7, 2019 to Le et al., provides a jet assembly having a friction-reducing member. This is directed to a jet assembly that has a jet assembly housing, a magnetic impeller and at least one friction-reducing member. The fluid pump comprises a motor assembly and a jet assembly. The friction-reducing member allows a motor assembly to cause a magnetic impeller to rotate within a jet assembly housing and not make contact with an inner surface of the back cover of the jet assembly housing during operation of the jet assembly.

U.S. Pat. No. 10,288,071, issued on May 14, 2019 to Le et al., discloses an improved bearing and shaft assembly having an outer bearing member an inner bearing member. A shaft assembly has a shaft member, a shaft protection member, and a locking mechanism. The outer bearing member has a cavity for receiving the inner bearing member and fits within a cavity of an impeller. The shaft assembly is secured within a housing of the jet assembly. The shaft protection member has a cavity for receiving the shaft member. The shaft protection member fits within the cavity of the inner bearing member. The jet assembly may be coupled to a motor assembly. The jet assembly includes a housing that has at least one inlet aperture and at least one outlet aperture. An impeller is positioned within the cavity of the housing.

U.S. Pat. No. 10,451,071, issued on Oct. 22, 2019 to Le et al., teaches a fluid pump for dispensing a fluid to a massage apparatus. The fluid pump has a contactless fluid sensor for use with a liner. The pump includes a jet assembly, a motor assembly and a contactless fluid sensor. The pump further includes a mounting housing member, a gasket or seal, and a liner. The jet assembly is coupled or secured about the motor assembly. The jet assembly includes a jet assembly housing, a printed circuit board, a printed circuit board cover, a shaft assembly and an impeller. The jet assembly housing has a base, a top cover, and an impeller-receiving chamber. It also includes at least one inlet aperture and at least one outlet aperture.

U.S. Pat. No. 11,986,436, issued on May 21, 2024 to C. L. Luong, provides a pedicure chair with a pump. The jet pump has an impeller with a magnet that can be rotated by shaft having a magnetic drive plate. The impeller and the magnetic drive plate are separated from one another by at least one solid wall surface. The impeller can be located in a pump housing having a base and a cover. The base can have a surface housing so that the impeller can be in contact therewith and rotated against the surface of the surface bearing.

U.S. Patent Application Publication No. 2010/0239435, published on Sep. 23, 2010 to Le et al., shows a fluid dispensing apparatus having a motor with a first shaft in which the motor rotates the first shaft. A first magnetic element is coupled to the first shaft such that rotation of the first shaft causes rotation of the first magnetic element. A second magnetic element is coupled to a second shaft and is magnetically coupled to the first magnetic element such that a rotation of the first magnetic element causes rotation of the second magnetic element. An input section receives a fluid. An output section outputs the fluid. An impeller is coupled to the second magnetic element such that rotation of the second magnetic element causes rotation of the impeller. As such, the fluid in the input section will flow in the input section and out the output section.

U.S. Design Pat. No. 622,736, issued on Aug. 31, 2010 is a design of a jet pump housing.

U.S. Design Pat. No. D698,368, issued on Jan. 28, 2014 describes a magnetic pump wet end.

U.S. Reissue Pat. No. 46,655, reissued on Jan. 2, 2018 to Luong et al., provides a water jet mechanism for whirlpool effects in pedicures or other applications. This whirlpool foot bath for a pedicure chair has a housing with a removable cap and a rotor and stator magnetic motor within the housing. Water in the bath is circulated through an inlet in the cap and out to at least one outlet in the cap.

It is object to the present invention to provide a water massage apparatus that has rotatable jets.

It is another object to the present invention to provide water massage apparatus that covers a larger area of the feet and ankle of the user.

It is another object of the present invention to provide a water massage apparatus that has greater massage action.

It is another object of the present invention to provide water massage apparatus that utilizes no O-ring seals or gaskets.

It is another object of the present invention to provide a water massage apparatus which has rotatable outlet nozzles that rotate by action of the water within a housing.

It is another object of the present invention to provide a water massage apparatus which includes a water-dispensing nozzle that is not mechanically coupled to the motor.

It is still a further object of the present invention provide water massage apparatus that is relatively inexpensive and easy to use.

These and other objects and advantages of the present invention will become apparent from a reading of the attached specification and appended claims.

### SUMMARY OF THE INVENTION

The present invention is a water massage apparatus for use with a tub that contains a liquid. The water massage apparatus includes a motor having a shaft with a magnet affixed thereto, a housing having an interior, an impeller positioned within the interior of the housing, and a cap having at least a portion received within the housing. The motor is adapted to be affixed to an exterior surface of the tub such that the magnet faces the surface of the tub. The impeller has a magnetic surface that is magnetically attracted to the magnet of the motor. The impeller is rotatable within the housing and in correspondence to a rotation of the shaft of the motor. The cap has at least one jet outlet formed thereon or affixed thereto. The impeller is adapted to pass the liquid outwardly of this jet. The cap is driven in rotation by motion of the liquid within the interior of the housing.

In embodiments of the present invention, the at least one jet can comprise a pair of jet outlets positioned diametrically opposite to each other. The pair of jet outlets can be directed off-plane from each other. The pair of jet outlets can also be individually adjustable in terms of the angle of directing the fluid flow outwardly from the cap. The cap can have at least one inlet formed centrally thereof in a location between the pair of jet outlets.

In an embodiment of the present invention, the cap is freely rotatably mounted in the housing. The cap will have at least one offshoot nozzle formed therein or affixed thereto. This offshoot nozzle directs a flow of the fluid outwardly thereof so as to cause the rotation of the cap relative to the housing. This offshoot nozzle is positioned circumferentially away from the jet outlet. The offshoot nozzle is adapted to direct the flow of fluid so as to rotate the cap relative to the housing. In an embodiment of the present invention, the offshoot nozzle comprises a pair of offshoot nozzles positioned diametrically opposite to each other on the cap. One offshoot nozzle directs the flow of fluid in a direction opposite to a direction that another offshoot nozzle directs the flow of fluid. The offshoot nozzle will have a diameter less than the diameter of the jet outlet.

In a further alternative embodiment of the present invention, the cap has a plurality of counter-blades formed on the surface of the cap opposite the jet nozzle. The plurality of counter-blades can act individually or in combination with the offshoot nozzles. The plurality of counter-blades are adapted to interact with the fluid passed by the impeller so as to rotate the cap. Each of the plurality of counter-blades has an arcuate configuration generally radiating from the center of the cap. The cap has a plurality of inlets formed generally centrally of the cap. The plurality of inlets are respectively positioned between the plurality of counter-blades.

The impeller has a plurality of blades generally radiating outwardly from a center thereof. Each of the plurality of blades of the impeller are straight and positioned within the housing below the cap. The impeller has a body positioned within the housing. The body of the impeller has a circular cross-section in a plane parallel to the cap. The magnetic surface of the impeller is positioned in the body. The impeller has a plurality of blades radiating outwardly on the surface of the body opposite the magnetic surface. The impeller can have an indentation at the center of the body. The plurality of blades radiate outwardly from the center. The cap has a protrusion received in the indentation such as the protrusion is freely rotatable within the indentation.

The housing has a first portion with a circular interior. The impeller is positioned in the circular interior of the first portion of the housing. The housing has a second portion affixed to the first portion of the housing. The second portion receives a periphery of the cap therein such that the cap is freely rotatable within the second portion of the housing. The second portion of the housing has a circular opening at a surface opposite the first portion of the housing. The cap and the outlet nozzle extend outwardly of the housing through the circular opening. The second portion of the housing has a notch formed around an inner diameter thereof. The cap has a peripheral edge received in this notch. The first portion of the housing can be threaded, snap-fitted, or bayonet fitted to the second portion of the housing. The housing will have no O-rings or gaskets on an interior thereof. The second portion of the housing has a protrusion formed centrally thereof. The impeller has an indentation formed centrally thereof. The protrusion is received by the indentation such that the impeller is freely rotatable with respect to the first portion of the housing. In an alternative embodiment, the cap can be mounted on a spindle so as to be supported centrally within the housing and freely rotatable with or about the spindle.

This foregoing Section is intended to describe, with particularity, the preferred embodiments of the present invention. It is understood that modifications to these preferred embodiments can be made within the scope of the present claims. As such, this Section should not to be construed, in any way, as limiting of the broad scope of the present invention. The present invention should only be limited by the following claims and their legal equivalents.

### BRIEF DESCRIPTION OF DRAWINGS

FIG. 1 is an upper perspective view of a water massage apparatus in accordance with prior art.

FIG. 2 is a cross-sectional view of a tub that receives the water massage apparatus of the prior art.

FIG. 3 is an exploded view of the water massage apparatus of the prior art.

FIG. 4 is an upper perspective exploded view of the water massage apparatus of an embodiment of the present invention.

FIG. 5 is a bottom perspective exploded view of the water massage apparatus of the present invention.

FIG. 6 is a cross-sectional view of the housing, impeller and cap of the water massage apparatus of the present invention.

FIG. 7 is a plan view showing the impeller is used in the water massage apparatus of the present invention.

FIG. 8 is a cross-sectional view taken across lines 8-8 of FIG. 7 of the impeller of the water massage apparatus of the present invention.

FIG. 9 shows a bottom view of the cap of the present invention and, in particular, the use of the plurality of counter-blades.

FIG. 10 is a cross-sectional view showing the mounting of the cap and the mounting of the impeller within the housing of the water massage apparatus of the present invention.

### DETAILED DESCRIPTION OF THE INVENTION

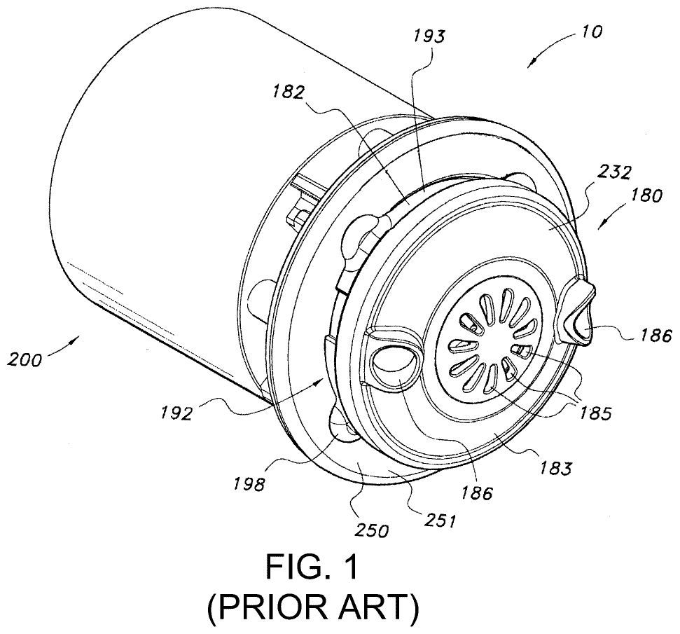

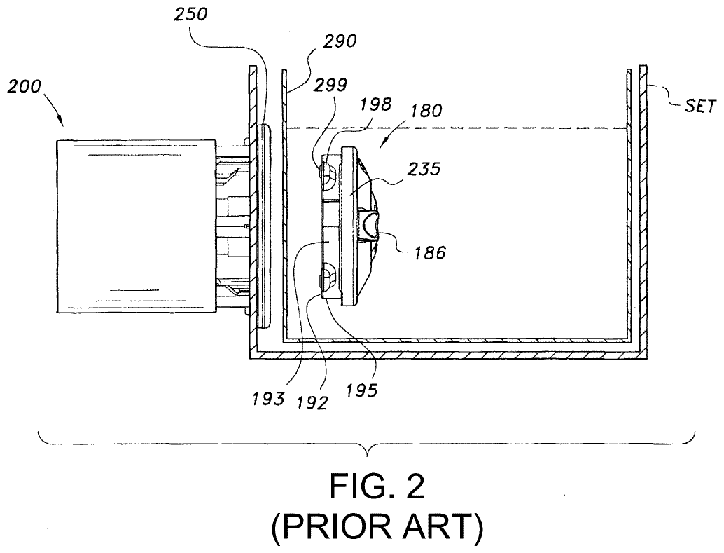

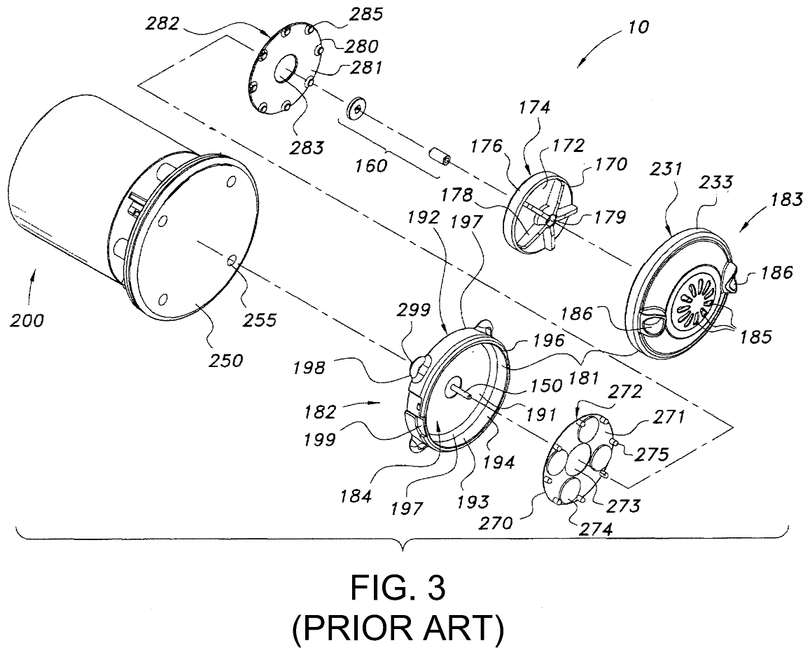

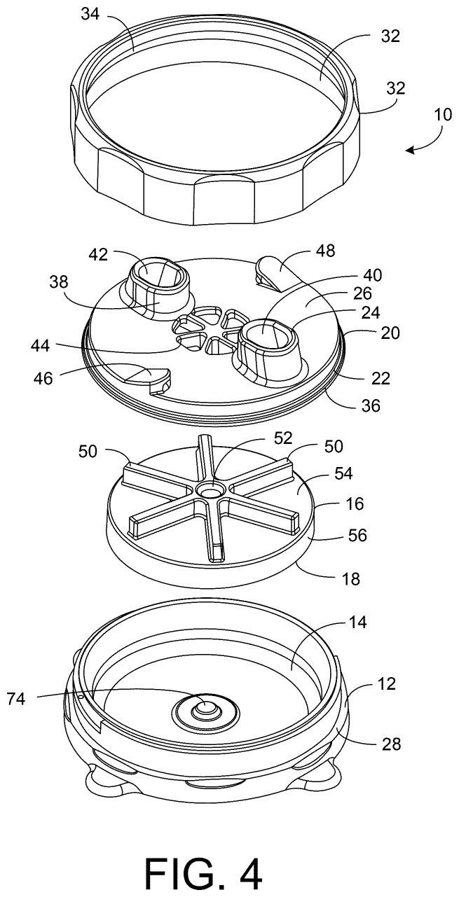

FIG. 4 is an exploded view showing the water massage apparatus 10 of the present invention. The water massage apparatus 10 is used in association with the configuration of the motor, shaft and mounting plate as shown in FIGS. 1-3 of the prior art hereinbefore. In particular, as can be seen in FIGS. 1-3 of the prior art, the motor will have a shaft on which a magnet is affixed to the shaft. The motor is adapted to be affixed to an exterior surface of the tub (as shown in FIG. 2) such that the magnet faces the surface of the tub. FIG. 4 shows that the water massage apparatus 10 includes a housing 12 having an interior 14. An impeller 16 is positioned in the interior of the housing 12. The impeller 16 will have a magnetic surface 18. The magnetic surface 18 of the impeller 16 is magnetically attracted to the magnet on the shaft of the motor. The impeller 16 is rotatable within the housing 12 in correspondence to a rotation of the shaft of the motor. A cap 20 has at least a portion 22 received within the interior 14 of the housing 12. The cap 20 has at least one jet outlet 24 formed on the surface 26 or affixed thereto. The impeller 16 is adapted to pass liquid outwardly of the outlet jet 24. The cap 20 is driven in rotation by motion of the liquid within the interior 14 of the housing 12.

FIG. 4 shows that the housing 12 includes a first portion 28 and a second portion 30. The first portion 28 can be affixed to the second portion 30 a by threaded connection, a snap-fit connection or a bayonet-style connection. The second portion 30 includes an opening 32 at the top thereof. The surface 26, along with the jet outlet 28, will extend outwardly of this opening 32. The second portion 30 also includes a notch 34 extending circumferentially around the interior of the second portion 30 of the housing 12. Notch 34 will receive the periphery 36 of the cap 20 therein. As such, this assembly is carried out without the use of O-rings or gaskets. When the second portion 30 is secured with the first portion 28 of the housing 12, the cap 20 and the impeller 16 will be received within the interior 14 of the housing 12.

In a preferred embodiment of the present invention, the jet outlet 24 can include another jet outlet 38. Jet outlet 38 is located diametrically opposite from jet outlet 24 on the surface 26 of the 20. The outlets 40 and 42 of the respective jet outlets 24 and 38 can be directed off-plane from each other such that the passage of the liquid through the outlets 40 and 42 can cause a rotation of the cap 20 with respect to the housing 12. Alternatively, each of the outlets 24 and 38 can be individually adjustable in terms of the direction of flow of fluid outwardly through the outlets 40 and 42 so that the orientation of the massage action can be individually adapted to the particular desires and needs of the individual.

The cap 20 has an inlet array 44 formed centrally thereof in a location between the pair of jet outlets 24 and 38. The cap 20 is freely rotatable in the housing 12. The cap has at least one offshoot nozzle 46 formed thereon or affixed thereto. The offshoot nozzle 44 directs a flow of fluid outwardly thereof. As can be seen in FIG. 4, the offshoot nozzle 46 directs the flow of fluid in a direction generally transverse to the flow of fluid that would pass from the outlets 40 and 42 of the respective jet outlets 24 and 38. As such, offshoot nozzle 46, individually or in combination with the jet outlets 24 and 38, can instill a rotatable motion to the cap 20 within the housing 12. The offshoot nozzle 46 can also include another offshoot nozzle 48. The offshoot nozzle 48 will direct the flow of fluid in a direction opposite to the direction of fluid flow from the offshoot nozzle 46. This further enhances the rotation capability of the cap 20 with respect to the housing 12. Each of the offshoot nozzles 46 and 48 will have an inner diameter much less than the inner diameter of the outlets 40 and 42 of the jet outlets 24 and 38. The offshoot nozzles 46 and 48 are not intended for massage action but rather rotation capability. The offshoot nozzle 46 is positioned circumferentially away from the jet outlets 24 and 38. The offshoot nozzle 46 is diametrically opposite the offshoot nozzle 48.

It can be seen that the inlets 44 comprise a plurality of inlets that are positioned between the jet outlets 24 and 38. As such, as water is being directed outwardly of the outlets 40 and 42 of the jet outlets 24 and 38, water is drawn through the inlets 44 into the interior 14 of the housing 12. This action of drawing the water through the inlets 44 and outwardly of the outlets 40 and 42 of the jet outlets 24 and 38 is carried out by the action of the impeller 16.

The impeller has a plurality of blades 50 that generally radiate outwardly from a center 52 thereof. The plurality of blades 50 are mounted upon the surface 54 of the impeller 16. Each of the plurality of blades 50 has a straight configuration. This plurality of blades 50 will be positioned beneath the cap 20 and located within the interior of the housing 12.

The impeller 16 has a body 56 positioned within the housing 12. The body 56 of the impeller 16 has a circular cross-section in a plane parallel to the cap 20. The magnetic surface 18 of the impeller 16 is positioned within the body 56. The plurality of blades 50 radiate outwardly on the surface 58 of the body 56 in a location opposite the magnetic surface 18. The center 52 includes an indentation. The plurality of blades 50 radiate outwardly from the center 52. As will be described hereinafter, the cap 20 will have a protrusion that is received within the indentation at the center 52 of the impeller 16. As such, this protrusion of the cap 20 will be freely rotatable within this indentation at the center 52 of the impeller 16.

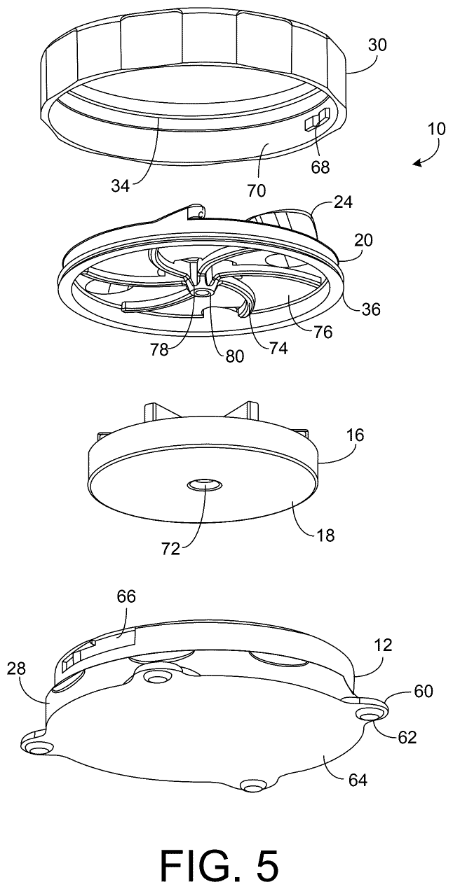

FIG. 5 illustrates the water massage apparatus 10 of the present invention from a bottom exploded view. In particular, FIG. 5 shows that the housing 12 has a first portion 28 and a second portion 30. A plurality of ears 60 radiate outwardly of the outer diameter of the first portion 28 of the housing 12. Ears 60 include indentations or openings 62 that are adaptable to be placed against the mounting plate on the inner wall of the tub (as shown in FIG. 2 herein). As such, the first portion 28 of the housing 12 will have a flat bottom surface 64. Housing 12 includes a bayonet-style connector 66 on an outer diameter thereof. This bayonet-style connector 66 is adapted to receive the bayonet or the bayonet-type member 68 on the inner wall 70 of the second portion 30 of housing 12. As such, the second portion 30 will be removable with respect to the first portion 28 of housing 12. If cleaning or maintenance is required for the water massage apparatus 10, the second portion 30 can be separated from the first portion 28 so as to access the impeller 16 and the cap 20 therein.

The impeller 16 is illustrated as having the magnetic surface 18 at a bottom thereof. An indentation 72 is formed centrally of the magnetic surface 18. Indentation 72 is adapted to fit upon the protrusion 74 (shown in FIG. 4) located within the interior 40 of the housing 12. As such, the impeller 16 is freely rotatable within the interior 14 of the housing 12 by virtue of this low-friction connection between the indentation 72 of the impeller 16 and the protrusion 74 of the housing 12. The magnetic surface 18 will interact with the magnet of the shaft of the motor so as to rotate in correspondence with the rotation of the shaft of the motor. This magnetic connection can be severed whenever it is necessary to install a new liner within the tub.

FIG. 5 shows that the cap 20 includes a plurality of counter-blades 74 formed on an inner surface 76 of the cap 20. The plurality of counter-blades 74 are opposite to the location of the jet nozzle 24. The plurality of counter-blades 74 are adapted interact with the fluid passed by the impeller 16 so as to rotate the cap 20 within the housing 12. Each of the plurality of counter-blades 74 has an arcuate configuration generally radiating from a center 78. A protrusion 80 extends downwardly from the center 78 of the cap 20. This protrusion 80 will be received by the indentation formed at the center 52 of impeller 16 (as shown in FIG. 4). As such, the cap 20 is mounted so as to be freely rotatable with respect to the impeller 16. The motion of the impeller 16 (caused by the magnetic interaction between the magnetic of the shaft of the motor and the magnetic surface 18 of the impeller 16) will cause a rotation of the impeller that drives the water through the inlets 44. Ultimately, the plurality of counter-blades 74 act as a scoop so as to direct the flow of fluid outwardly through the outlets 40 and 42 of the respective jet outlets 24 and 38.

The second portion 30 of the housing 12 can be secured to the first portion 28 so as to enclose the cap 20 and the impeller 16 within the interior 14 of the housing 12. As stated hereinbefore, the second portion 30 of the housing 12 includes a notch 34. Notch 34 will receive the periphery 36 of the cap 20.

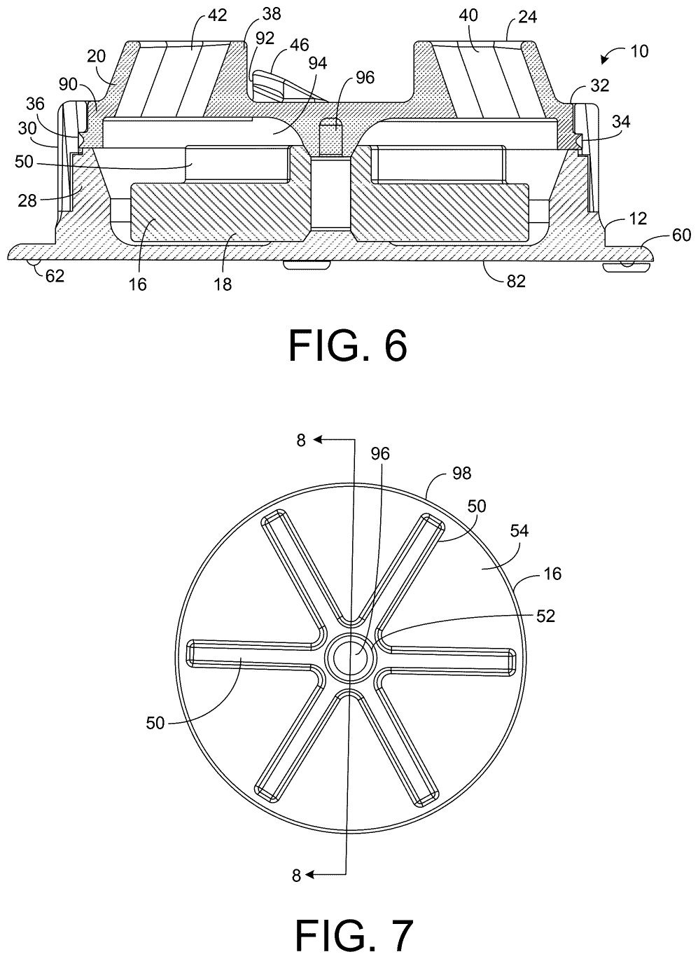

FIG. 6 is a cross-sectional view of the assembled water massage apparatus 10 of the present invention. In particular, FIG. 6 shows the housing 12 as having the first portion 28 removably affixed to the second portion 30. The first portion 28 of housing 12 includes ears 60 radiating outwardly from the base 82 of the first portion 28 of housing 12. Bumps 62 can engage with suitable openings formed on the mounting plate on the inner wall of the tub (as shown in FIG. 2 hereinbefore).

In FIG. 6, it can be seen that the impeller 16 has magnetic surface 18 thereon. Magnetic surface 18 faces the base 82 of the first portion 28 of housing 12. Since the housing 12 is formed of a polymeric material, it will not block the magnetic interaction between the magnet on the shaft of the motor with the magnetic surface 80 of the impeller 16. Blades 50 of impeller 16 radiate outwardly from a center thereof.

The cap 20 has a portion 90 received within the second portion 30 of the housing 12. In particular, the periphery 36 of the cap 20 is received within the notch 34 formed on the inner wall of the second portion 30 of the housing 12. This type of mounting between the periphery 36 and a notch 34 will allow the cap 20 to freely rotate on the interior of the housing 20 without the use of seals, O-rings or gaskets. This plastic-to-plastic connection establishes a leakproof configuration while, at the same time, allowing free rotation between the cap 20 and the inner surfaces of the housing 60.

Jet outlets 24 and 38 are illustrated as extending upwardly and outwardly of the second portion 30 of the housing 12. In particular, these extend outwardly of the circular opening 32 of the second portion 30 of the housing 12. The jet outlets 24 and 38 include respective outlets 40 and 42 so as to direct the flow of liquid outwardly therefrom. FIG. 6 shows that the outlets 40 and 42 tend to direct the fluid flow in a converging manner. The jet outlets 24 and 38 can be individually adjustable so that this angle can be adjusted. It can be seen that the outlets 40 and 42 are off-plane from each other.

An offshoot jet 46 is shown as positioned above the cap 20. The offshoot nozzle 46 will have an outlet 92. This outlet 92 is has an inner diameter significantly smaller than the inner diameter of the outlets 40 and 42 of the respective jet outlets 24 and 38. The offshoot nozzle 46 is only intended to provide rotation capability to the cap 20.

Ultimately, in normal use, the impeller 16 will be rotated by magnetic interaction with the magnet of the shaft of the motor. As the impeller 16 rotates, the blades 50 will drive water through the inlets 44 on the cap 20. This water will flow through channel 94 and ultimately outwardly of the cap 20 through the outlets 40 and 42 of the jet outlets 24 and 38. This force of water will also flow outwardly of the outlet 92 of the offshoot nozzle 46. The cap 20 will continuously rotate during this motion so that a rotating and continuously variable massaging action is achieved within the tub of the foot spa.

FIG. 6 shows that the cap 20 is mounted on a spindle 96. Spindle 96 only serves to center the 20 within the interior of the housing 12. When the cap 20 rotates, the spindle 96 will also rotate independently of the rotation of the impeller 16 or the cap well rotate independently of the spindle 96.

It is important to note herein that the rotation of the cap 20 can be achieved in several ways. First, rotation can be achieved solely by the orientation of the outlets 40 and 42 of the jet outlets 24 and 38. To the extent that the jet outlets 24 and 38 are individually angularly adjustable, the angle can be adjusted so that the flow of liquid outwardly of the outlets 40 and 42 causes a rotation in the cap 20. Secondly, the use of the offshoot nozzles 46 and 48 can impart a rotation to the cap 20. When the jet outlets 24 and 38 are in a fixed position on the cap 20, these offshoot nozzles 46 and 48 provide propulsion for the rotation of the cap 20. Thirdly, a rotation of the cap can be achieved through the use of the plurality of counter-blades 74 located on the underside of the cap 20. These blades will interact with the flow of water propelled by the impeller so as to rotate the cap 20 relative to the housing 12. Rotation can also be achieved by any combination of these particular features. As such, with the concept of the present invention, the orientation of the particular outlets 40 and 42 of the jet outlets 24 and 38 can be adapted in combination with either the offshoot nozzles or with the counter-blades so as to create this rotation. Alternatively, the offshoot nozzles can also be used with the counter-blades so as to create this motion. All three of these features can further be used, in combination, so as to assure that the cap 20 rotates with respect to the housing.

Ultimately, the rotation of the cap, along with the movement of the water through the outlets 40 and 42 of the outlet nozzles 24 and 38 creates a beneficial massage apparatus to those using the massage apparatus of the present invention. The rotation of the cap along with the rotational movement of fluid outwardly of the outlets 40 and 42 of the jet outlets 24 and 38 creates both a pulsing action and a swirling action within the fluid in the tub. The pulsing action is continuously variable and is directed to various portions of the foot and ankle of the user. The swirling action creates a smooth and soothing effect upon the entirety of the ankle and foot. As such, a more comprehensive and satisfying foot massage experience is achieved with the water massage apparatus of the present invention.

FIG. 7 is an isolated view showing the impeller 16. Impeller 16 is shown as having the plurality of blades 50 radiating outwardly of the center 52. Center 52 includes indentation 96 therein. A total of six blades 50 are shown on the surface 54 of the impeller 16. Each of the blades 50 are equally circumferentially spaced from each other and extend toward the periphery 98 of the impeller 16.

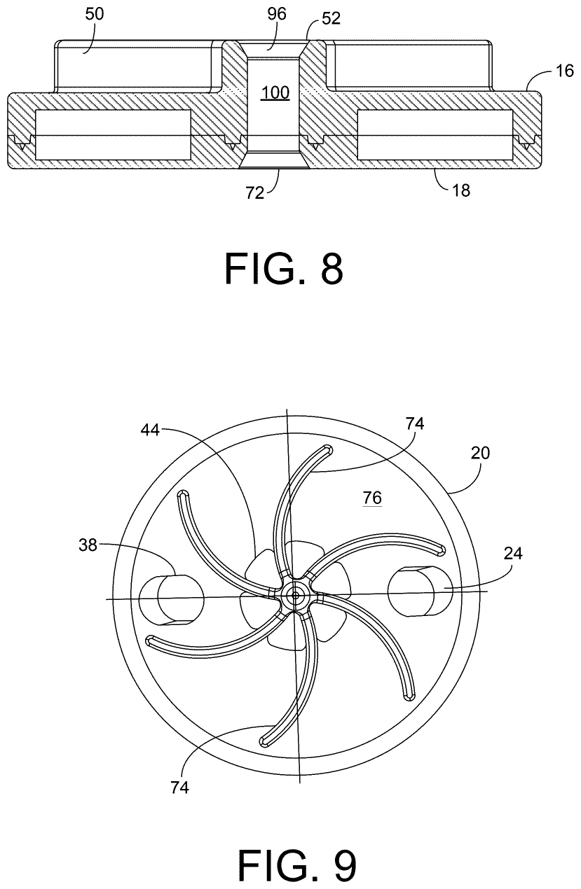

FIG. 8 is a cross-sectional view of the impeller 16 as taken across lines 8-8 of FIG. 7. FIG. 8 illustrates the configuration of the blades 50. The center 52 includes the aperture 96. Aperture 96 is adapted to receive the protrusion 80 at the bottom of the cap 20 so as to allow relative rotational motion therebetween. A passageway 100 extends from indentation 96 so as to open to another indentation 100 and indentation 72 located at the magnetic surface 18 of impeller 16. Indentation 72 can rest upon the protrusion 74 located within the interior 14 of the housing 12. This configuration avoids the need for spindles, shafts and other connection mechanisms. This configuration of indentations and protrusions allows a smooth and centered rotation capability to each of the components of the massage apparatus of the present invention.

FIG. 9 is a bottom view of the 20 and, in particular shows the plurality of counter-blades 74 positioned at the bottom surface 76 of the cap 20. Jet outlets 24 and 38 are illustrated as opening through this surface 76. The plurality of inlets 44 will be respectively positioned between the plurality of blades 74. In normal use, as the plurality of blades 74 rotate, they will scoop the water as it passes through the inlets 44 so as to drive the rotation of the cap 20. Ultimately, they will urge the water outwardly of the jet outlets 24 and 38.

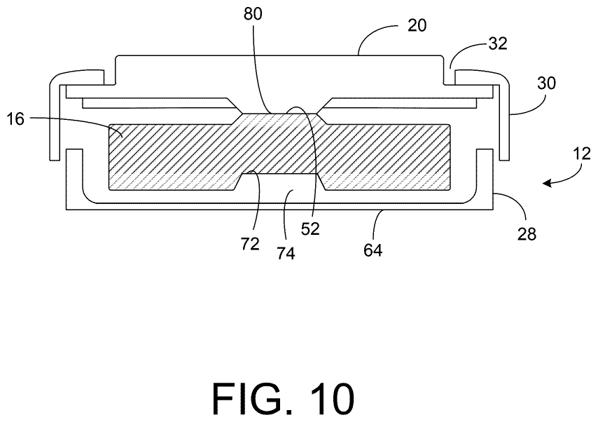

FIG. 10 illustrates the assembly of the present invention in which the housing 12 has the first portion 28 removably affixed to the second portion 30. The protrusion 74 is illustrated as extending upwardly from the base 64 of the first portion 28 of housing 12. The indentation 72 of the impeller 16 will rest on the protrusion 74 in a freely rotating manner. The cap 20 is illustrated as having a portion extending outwardly of the circular opening 32 at the top of the second portion 30 of the housing 12. The protrusion 80 of the cap 20 is illustrated as being received within the indentation 52 at the top of the impeller 16.

The foregoing disclosure and description of the invention is illustrative and explanatory thereof. Various changes in the details of the illustrated construction can be made within the scope of the appended claims without departing from the true spirit of the invention. The present invention should only be limited by the following claims and their legal equivalents.

1. A water massage apparatus for use with a tub that contains a liquid, the water massage apparatus comprising:
a motor having a shaft, the shaft having a magnet affixed thereto, said motor being adapted to be affixed to an exterior surface of the tub such that the magnet faces the exterior surface of the tub;
a housing having an interior;
an impeller positioned in the interior of said housing, said impeller having a magnetic surface, the magnetic surface of said impeller being magnetically attracted to the magnet of said motor, said impeller being rotatable within said housing in correspondence to a rotation of the shaft of said motor; and
a cap having at least a portion received within said housing, said cap having at least one jet outlet formed thereon or affixed thereto, said impeller adapted to pass the liquid outwardly of the at least one jet, said cap being driven in rotation by motion of the liquid within the interior of said housing.

2. The water massage apparatus of claim 1, the at least one jet comprising a pair of jet outlets positioned diametrically opposite to each other on said cap.

3. The water massage apparatus of claim 2, a pair of jet outlets being directed off-plane from each other.

4. The water massage apparatus of claim 2, said cap having at least one inlet formed generally centrally thereof in a location between the pair of jet outlets.

5. The water massage apparatus of claim 1, said cap being freely rotatably mounted in said housing, said cap having at least one offshoot nozzle form thereon or affixed thereto, the at least one offshoot nozzle directing a flow of the fluid outwardly thereof.

6. The massage apparatus of claim 5, the at least one offshoot nozzle positioned circumferentially away from the at least one jet outlet, the at least one offshoot nozzle adapted to direct the flow of the fluid so as to rotate said cap relative to said housing.

7. The water massage apparatus of claim 6, wherein the at least one offshoot nozzle comprises a pair of offshoot nozzles positioned diametrically opposite to each other on said cap, one offshoot nozzle of the pair of offshoot nozzles directing the flow of fluid in a direction opposite to a direction that another offshoot nozzle of the pair of offshoot nozzles directs the flow of fluid.

8. The massage apparatus of claim 5, wherein the at least one offshoot nozzle has a diameter less than a diameter of the at least one jet outlet.

9. The water massage apparatus of claim 1, wherein said cap has a plurality of counter-blades formed on the surface of said cap opposite the at least one jet nozzle, the plurality of counter-blades adapted to interact with the fluid passed by said impeller so as to rotate said cap.

10. The water massage apparatus of claim 9, each of the plurality of counter blades having an arcuate configuration generally radiating from a center of said cap.

11. The water massage apparatus of claim 10, said cap having a plurality of inlets formed generally centrally of said cap, the plurality of inlets respectively positioned between the plurality of counter-blades.

12. The massage apparatus of claim 1, said impeller having a plurality of blades generally radiating outwardly from a center thereof.

13. The water massage apparatus of claim 12, each of the plurality of blades of said impeller being straight and positioned within said housing below said cap.

14. The water massage apparatus of claim 1, said impeller having a body positioned within said housing, the body of said impeller having a circular cross-section in a plane parallel to said cap, the magnetic surface of said impeller being positioned in the body, said impeller having a plurality of blades radiating outwardly on a surface of the body opposite the magnetic surface.

15. The water massage apparatus of claim 14, said impeller having an indentation at a center of said body, the plurality of blades radiating outwardly from the center, said cap having a protrusion received in the indentation such that the protrusion is freely rotatable within the indentation.

16. The water massage apparatus of claim 1, said housing comprising:
a first portion having a circular interior, said impeller being positioned in the circular interior of the first portion of said housing; and
a second portion affixed to said first portion of said housing, said second portion receiving a periphery of said cap therein such that said cap is freely rotatable within said second portion of said housing.

17. The water massage apparatus of claim 16, said second portion of said housing having a circular opening on a surface opposite said first portion of said housing, said cap and the at least one outlet nozzle extending outwardly of said housing through the circular opening.

18. The water massage apparatus of claim 16, said second portion of said housing having a notch formed around an inner diameter of said second portion of said housing, said cap having a peripheral edge received in the notch.

19. The water massage apparatus of claim 16, said second portion of said housing being threaded or snap-fitted to the second portion of said housing, said housing having no O-ring seals on an interior thereof.

20. The water massage apparatus of claim 16, said second portion of said housing having a protrusion formed centrally thereof, said impeller having an indentation formed centrally thereof, the protrusion being received by the indentation such that said impeller is freely rotatable with respect to said first portion of said housing.
